(19) United States
(12) Patent Application Publication
(10) Pub. No.: US 2014/0284527 A1
(43) Pub. Date: Sep. 25, 2014

(54) PHOTO-CURING CONDUCTIVE ADHESIVE FOR TOUCH PANEL

(71) Applicant: Eturbotouch Technology Inc., Zhongli City (TW)

(72) Inventors: TA-HU LIN, TAIPEI CITY (TW); KUEI-CHING WANG, LONGTAN TOWNSHIP (TW)

(73) Assignee: Eturbotouch Technology Inc., Zhongli City (TW)

(21) Appl. No.: 14/058,402

(22) Filed: Oct. 21, 2013

(30) Foreign Application Priority Data
Mar. 22, 2013 (TW) 102110299

(51) Int. Cl. C09J 9/02

(52) U.S. Cl. CPC C09J 9/02
USPC 252/514

(57) ABSTRACT

A photo-curing conductive adhesive for a touch panel includes an adhesive in an amount within the range of 20 to 30 wt % and the metal particle composition in an amount within the range of 70 to 80 wt %.

### CROSS-REFERENCE TO RELATED APPLICATION

This non-provisional application claims priority under 35 U.S.C. §119(a) on Patent Application No(s).102110299 filed in Taiwan, R.O.C. on Mar. 22, 2013, the entire contents of which are hereby incorporated by reference.

### FIELD OF TECHNOLOGY

The present invention relates to conductive adhesives, and more particularly, to a photo-curing conductive adhesive for a touch panel.

### BACKGROUND

Due to rapid development of the electronic industry, various touch input technologies are widely applied to electronic products, such as mobile phones and tablet computers, each using a touch panel as an input interface, such that a user can touch the screen of the touch panel with the user's fingers to give an instruction to the touch panel, move a cursor across the screen of the touch panel, or perform Chinese handwriting input. A display panel operating in conjunction with the touch panel displays a virtual keyboard for use by the user, such that the user can enter related words with the virtual keyboard.

To enable electronic products flexible, lightweight, and thin, flexible substrate materials are extensively used in the manufacturing of the electronic products thus designed. Furthermore, when it comes to circuit layout, flexible substrate materials cannot work without a conductive adhesive which functions as a path of electrical conduction or serves to fix small electronic components in place.

In general, most flexible substrate materials cannot survive high heat (at about 300° C.), whereas most conventional conductive adhesives are thermo-curing conductive adhesives which can be sintered and cured only when processed at high temperature. As a result, to apply thermo-curing conductive adhesives to flexible substrate materials, it is necessary to perform a high-temperature curing process on the conductive adhesives for a long period of time at the cost of causing damage to the flexible substrate materials and consuming power. If the aforesaid curing process is carried out at a relatively low temperature, the resultant sintering temperature will be too low to bond together the conductive materials in the conductive adhesives effectively, thereby compromising the electrical conduction characteristics of the conductive adhesives.

Accordingly, it is imperative to provide a conductive adhesive adapted for use with a touch panel and conducive to reducing the required curing temperature, increasing the curing speed, preventing a waste of energy, ensuring an appropriate degree of electrical conductive property, and meeting the high electrical conductivity requirement and high resolution requirement of touch panels.

### SUMMARY

In view of the aforesaid drawbacks of the prior art, it is an objective of the present invention to provide a photo-curing conductive adhesive adapted for use with a touch panel and conducive to reducing the required curing temperature, increasing the curing speed, preventing a waste of power, ensuring an appropriate degree of electrical conductive property, and meeting the high electrical conductivity requirement and high resolution requirement of touch panels.

In order to achieve the above and other objectives, the present invention provides a photo-curing conductive adhesive for a touch panel, wherein the photo-curing conductive adhesive comprises 20% to 30% of an adhesive and 70% to 80% of a metal particle composition.

In an embodiment of the present invention, an adhesive is a resin comprising a copolymerized resin and an acrylic acid resin.

In an embodiment of the present invention, the copolymerized resin is 9% by weight, and the acrylic acid resin is 5.5% by weight.

In an embodiment of the present invention, the metal particle composition comprises silver powder or silver particles, wherein silver particles comprise flakelike silver particles.

In an embodiment of the present invention, the metal particle composition comprises a first metal particle composition and a second metal particle composition, and the first metal particle composition is twofold that of the second metal particle composition by weight.

In an embodiment of the present invention, 90% w/w of the metal particles in the first metal particle composition have a particle diameter of less than 4.74 μm, 50% w/w of the metal particles in the first metal particle composition have a particle diameter of less than 1.57 μm, and 10% w/w of the metal particles in the first metal particle composition have a particle diameter of less than 0.62 μm.

In an embodiment of the present invention, 90% w/w of the metal particles in the second metal particle composition have a particle diameter of less than 10.57 μm, 50% w/w of the metal particles in the second metal particle composition have a particle diameter of less than 4.63 μm, and 10% w/w of the metal particles in the second metal particle composition have a particle diameter of less than 2.18 μm.

In an embodiment of the present invention, an adhesive accounts for 25% of the photo-curing conductive adhesive by weight, and the metal particle composition accounts for 75% of the photo-curing conductive adhesive by weight.

In an embodiment of the present invention, photo-curing conductive adhesive further comprises a photoinitiator, a photosensitizer, a leveling agent, or an organic solvent, wherein the photoinitiator accounts for about 1% of the photo-curing conductive adhesive by weight.

In an embodiment of the present invention, the photo-curing conductive adhesive is transparent.

In an embodiment of the present invention, the photo-curing conductive adhesive has viscosity of 20,000 cP to 35,000 cP, thixotropy of 4 or greater, and electrical resistivity of 47 μΩ·cm to 49 μΩ·cm.

In conclusion, as disclosed in the present invention, a photo-curing conductive adhesive for a touch panel comprises 20% w/w to 30% w/w of an adhesive and 70% w/w to 80% w/w of the metal particle composition to reduce the required curing temperature, increase the curing speed, avoid a waste of energy, ensure an appropriate degree of electrical conductive property, and meet the high electrical conductivity requirement and high resolution requirement of touch panels. Accordingly, the photo-curing conductive adhesive of the present invention is advantageously applicable to flexible substrate materials.

### BRIEF DESCRIPTION

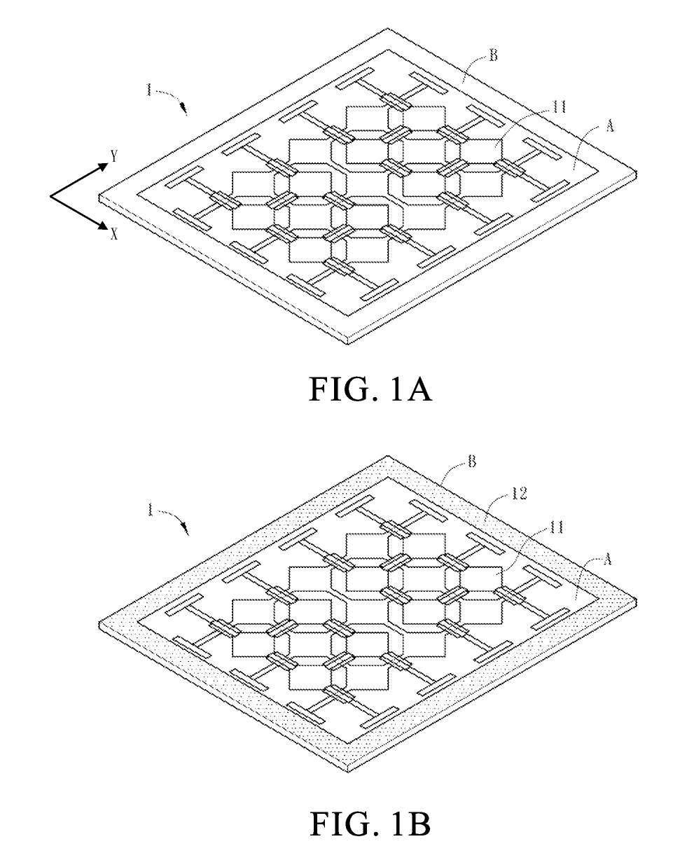

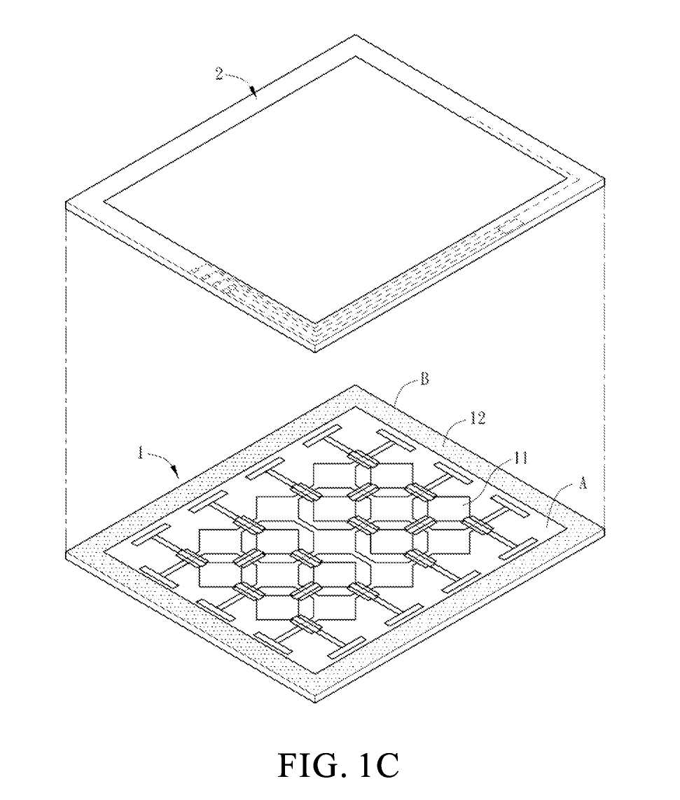

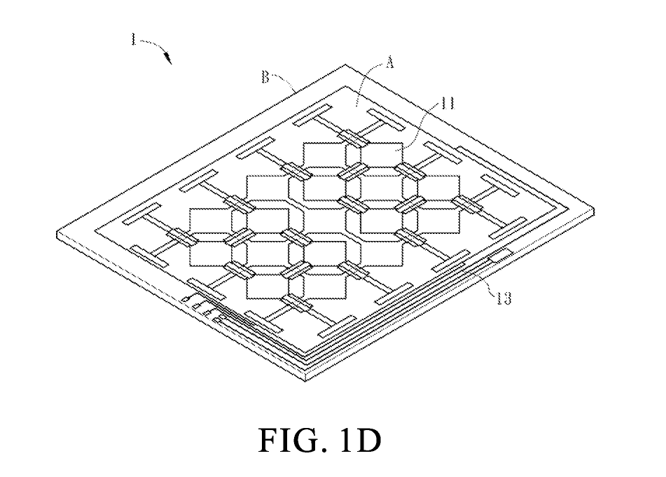

FIG 1A through FIG. 1D are schematic views of a method for manufacturing a touch panel according to a preferred embodiment of the present invention.

### DETAILED DESCRIPTION

A photo-curing conductive adhesive for a touch panel according to a preferred embodiment of the present invention is described below.

Referring to FIG 1A through FIG. 1D, there are shown schematic views of a process flow of the manufacturing of the photo-curing conductive adhesive of the present invention.

The photo-curing conductive adhesive of the present invention is adapted for use with a touch panel, especially a touch panel made from a flexible substrate, and is intended to be applied to an ultrathin, flexible touch panel. The flexible substrate is soft glass, plastic board, or plastic thin film, for example. In this regard, the plastic is polyethylene terephthalate (PET).

Referring to FIG. 1A, in practice, a plurality of electrical conductive patterns 11 is formed within a touch area A defined on a flexible substrate 1 to enable touch-control and sensing. The electrical conductive patterns 11 are arranged alternately. The electrical conductive patterns 11 are electrically connected transversely (in the direction X) and longitudinally (in the direction Y).

Referring to FIG. 1B, a photo-curing conductive adhesive 12 is applied to a peripheral circuit region B enclosing the touch area A. The photo-curing conductive adhesive 12 is sticky and manifests, after being sintered, electrical conductive property. The photo-curing conductive adhesive 12 comprises an adhesive and a metal particle composition. The adhesive is provided in the form of a photo-curing adhesive. the photo-curing adhesive can be irradiated in order to be cured rather than subjected to high-temperature thermo-curing so as to protect the flexible substrate 1 against high temperature-induced damage. If the metal particle composition is mixed with too much adhesive, the electrical conductive property of the photo-curing conductive adhesive 12 sintered will deteriorate. Although it is feasible to enhance electrical conductive property by increasing the metal particle composition content and thus increasing the probability that they are bonded to each other, a plethora of the metal particle composition hides the adhesive and thus not only compromises the adhesiveness of the adhesive but also hampers the intermolecular bonding of the adhesive during the curing process, thereby affecting the curing speed of the adhesive and ultimate extent of curing. By contrast, with considerations being given to adhesiveness, electrical conductive property, and curing speed, in this embodiment, the photo-curing conductive adhesive 12 comprises 20% w/w to 30% w/w of the adhesive and 70% w/w to 80% w/w of the metal particle composition. Preferably, the photo-curing conductive adhesive 12 comprises 25% w/w of the adhesive and 75% resin which mix. The photo-curing conductive adhesive 12 comprises about 9% w/w of the copolymerized resin and about 5.5% w/w of the acrylic acid resin.

The metal particle composition comprises metallic powder or metal particles. Preferably, the metal particle composition comprises metallic powder and metal particles, because the electrical conductive property of the photo-curing conductive adhesive 12 depends on the shape and size of the metal particle composition; in this regard, the metal particle composition provided in the form of a mixture of powder and particles is most desirable. Hence, the metal particle composition includes at least two compositions of obviously different dimensions. The metallic powder or metal particles are filament-shaped, branch-like, spherical, or flakelike. Not only must considerations be given to the superficial orientation of an electrode of the touch panel in terms of position and production thereof, but flakelike metallic powder or metal particles also come into contact with each other by the surfaces thereof; hence, flakelike metallic powder or metal particles surpass spherical, branch-like, and filament-shaped metallic powder or metal particles in terms of electrical conductive property, as far as the application of the touch panel is concerned.

In addition to size and shape, considerations must be given to materials. Silver manifests higher electrical conductive property than the other metals. Hence, the metal particle composition preferably comprises silver particles to meet application requirements of the touch panel, wherein the silver particle composition comprises silver powder and silver particles.

As regards the curing mechanism of the photo-curing conductive adhesive 12 of the present invention, when irradiated by high-energy electromagnetic wave, the adhesive undergoes chemical or physical changes and thus cures, including bridging, cross-linking, decomposition, or isomerism, wherein the electromagnetic wave is exemplified by ultraviolet (UV), electron beam, or X-ray. To this end, the adhesive of the photo-curing conductive adhesive 12 further comprises a photoinitiator, a photosensitizer, a leveling agent, or an organic solvent. The photoinitiator is, for example, phosphine oxide, and accounts for about 1% of the photo-curing conductive adhesive 12 by weight. The photosensitizer is, for example, benzophenone. The photo-curing conductive adhesive 12 contains the same amount of the photosensitizer and the photoinitiator by weight.

The organic solvent comprises diethylene glycol monoethyl ether acetate, propylene glycol mono-methyl ether acetate, and a high-boiling-point petroleum solvent, which account for 6.7%, 0.1%, and 4.3% of the photo-curing conductive adhesive 12 by weight approximately, but the present invention is not limited thereto. The organic solvent not only facilitates the passage of a screen panel and prevents panel clogging before the screen printing process begins, but also renders the screen printing process quick in drying and overflow-free.

To enhance the electrical conductive property of the photo-curing conductive adhesive 12, in practice, the metal particle composition comprises a first metal particle composition and a second metal particle composition. The first metal particle composition is twofold that of the second metal particle composition by weight. For example, the first metal particle composition accounts for 50% of the photo-curing conductive adhesive 12 by weight, and the second metal particle composition accounts for 25% of the photo-curing conductive adhesive 12 by weight. The first metal particles and the second metal particles are preferably made of silver.

In this embodiment, 90% w/w of the metal particles in the first metal particle composition have a particle diameter of less than 4.74 μm, 50% w/w of the metal particles in the first metal particle composition have a particle diameter of less than 1.57 μm, and 10% w/w of the metal particles in the first metal particle composition have a particle diameter of less than 0.62 μm. In this embodiment, 90% w/w of the metal particles in the second metal particle composition have a particle diameter of less than 10.57 μm, 50% w/w of the metal particles in the second metal particle composition have a particle diameter of less than 4.63 μm, and 10% w/w of the metal particles in the second metal particle composition have a particle diameter of less than 2.18 μm.

Hence, two different metal particle compositions each comprise metal particles of different sizes (i.e., dimensions). The different metal particle compositions are introduced into an adhesive to thereby enhance superficial contact, which in turn enhances the electrical conductive property of the photo-curing conductive adhesive 12.

The photo-curing conductive adhesive 12 of the present invention is transparent and has viscosity of 20,000 cP to 35,000 cP, thixotropy of 4 or greater, and electrical resistivity of 47 μΩ·cm to 49 μΩ·cm. Hence, the photo-curing conductive adhesive 12 not only manifests satisfactory transparency, high adhesiveness, and high curing speed, but also demonstrates good electrical conductive property.

Hence, a screen printing process can be included in the process of manufacturing a touch panel with the flexible substrate 1 whenever the photo-curing conductive adhesive 12 is used in the touch panel manufacturing process. As the viscosity of the photo-curing conductive adhesive 12 ranges from 20,000 cP to 35,000 cP, the photo-curing conductive adhesive 12 prevents panel clogging and panel sticking during the screen printing process.

Referring to FIG. 1C, after the photo-curing conductive adhesive 12 has been screen-printed on the flexible substrate 1, the photo-curing conductive adhesive 12 is dried and cured quickly with a photomask 2 and by irradiation, without overflowing the flexible substrate 1. Then, the photo-curing conductive adhesive 12 thus dried and cured undergoes development and low-temperature baking, wherein the low-temperature baking takes place below 100° C. at 70° C. Referring to FIG. 1D, with the photo-curing conductive adhesive 12 being cured quickly and unlikely to overflow, the photo-curing conductive adhesive 12 forms one or more conductive circuits 13, and thus the photo-curing conductive adhesive 12 is suitable for use in printing an electrode (not shown) or the conductive circuits 13 with a pitch less than or equal to 70 μm to thereby enhance the resolution of the touch panel.

According to the present invention, the weight percent concentration of the ingredients of the photo-curing conductive adhesive 12 does allow for measurement errors and apply to any ingredients which are of similar weight percent concentration and provide the same or similar functions substantially.

A point to note is that the present invention is characterized in that the electrical conductive patterns 11 are electrically connected in the direction X and the direction Y and disposed on the same substrate (the flexible substrate 1). By contrast, according to the prior art, electrical conductive patterns are electrically connected in the direction X and disposed on a substrate, whereas other electrical conductive patterns are electrically connected in the direction Y and disposed on another substrate. Hence, the present invention is simpler than the prior art and thus features enhanced yield and requires lesser processes and auxiliary materials, such as a transparent adhesive, a thin film, or a glass lid, thereby cutting manufacturing costs, reducing the total thickness and volume of the touch panel, and facilitating product miniaturization. As regards the manufacturing costs incurred by the present invention, they are low, because the present invention uses one piece of substrate and optical plastic layer instead of two pieces of substrate and optical plastic layer as taught by the prior art.

The present invention provides the photo-curing conductive adhesive 12 for a touch panel, comprising 20% w/w to 30% w/w of an adhesive and 70% w/w to 80% w/w of the metal particle composition to reduce the required curing temperature, increase the curing speed, avoid a waste of energy, ensure an appropriate degree of electrical conductive property, and meet the high electrical conductivity requirement and high resolution requirement of touch panels. Accordingly, the photo-curing conductive adhesive 12 is advantageously applicable to flexible substrate materials.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A photo-curing conductive adhesive for a touch panel, comprising 20% w/w to 30% w/w of an adhesive and 70% w/w to 80% w/w of a metal particle composition.

2. The photo-curing conductive adhesive of claim 1, wherein the adhesive is a resin.

3. The photo-curing conductive adhesive of claim 2, wherein the resin comprises a copolymerized resin and an acrylic acid resin.

4. The photo-curing conductive adhesive of claim 3, wherein the copolymerized resin is 9% by weight and the acrylic acid resin is 5.5% by weight.

5. The photo-curing conductive adhesive of claim 1, wherein the metal particle composition comprises one of silver powder and silver particles.

6. The photo-curing conductive adhesive of claim 5, wherein the silver particles comprise flakelike silver particles.

7. The photo-curing conductive adhesive of claim 1, wherein the metal particle composition comprises a first metal particle composition and a second metal particle composition, and the first metal particle composition is twofold that of the second metal particle composition by weight.

8. The photo-curing conductive adhesive of claim 7, wherein 90% w/w of the metal particles in the first metal particle composition have a particle diameter of less than 4.74 μm, 50% w/w of the metal particles in the first metal particle composition have a particle diameter of less than 1.57 μm, and 10% w/w of the metal particles in the first metal particle composition have a particle diameter of less than 0.62 μm.

9. The photo-curing conductive adhesive of claim 7, wherein 90% w/w of the metal particles in the second metal particle composition have a particle diameter of less than 10.57 μm, 50% w/w of the metal particles in the second metal particle composition have a particle diameter of less than 4.63 μm, and 10% w/w of the metal particles in the second metal particle composition have a particle diameter of less than 2.18 μm.

10. The photo-curing conductive adhesive of claim 1, further comprising 25% of the adhesive and 75% w/w of the metal particles.

11. The photo-curing conductive adhesive of claim 1, further comprising one of a photoinitiator, a photosensitizer, a leveling agent, and an organic solvent.

12. The photo-curing conductive adhesive of claim 11, wherein the photoinitiator accounts for about 1% of the photo-curing conductive adhesive by weight.

13. The photo-curing conductive adhesive of claim 1, wherein the photo-curing conductive adhesive is transparent.

14. The photo-curing conductive adhesive of claim 1, wherein the photo-curing conductive adhesive has viscosity of 20,000 cP to 35,000 cP, thixotropy of 4 or greater, and electrical resistivity of 47 μΩ·cm to 49 Ω·cm.
